(19) United States
(12) Patent Application Publication
(10) Pub. No.: US 2017/0248080 A1
(43) Pub. Date: Aug. 31, 2017

(54) DEVICE AND METHOD FOR STARTING A GAS TURBINE, METHOD FOR REGULATING THE ROTATION SPEED OF A GAS TURBINE, AND ASSOCIATED GAS TURBINE AND TURBINE ENGINE

(71) Applicants: SAFRAN POWER UNITS, Toulouse (FR); SAFRAN ELECTRICAL & POWER, Blagnac (FR)

(72) Inventors: Stephane CHEVALIER, Colomiers (FR); Fabien SILET, Pechbonnieu (FR); Alexis RENOTTE, Toulouse (FR)

(73) Assignees: SAFRAN POWER UNITS, Toulouse (FR); SAFRAN ELECTRICAL & POWER, Blagnac (FR)

(21) Appl. No.: 15/506,147

(22) PCT Filed: Aug. 21, 2015
(86) PCT No.: PCT/FR2015/052247

§ 371 Date: Feb. 23, 2017

(30) Foreign Application Priority Data
Aug. 29, 2014 (FR) 1458114

(51) Int. Cl. F02C 7/275; F02C 9/28; F02C 9/26

(52) U.S. Cl. CPC F02C 7/275; F02C 9/263; F02C 9/28; F05D 2260/85; F05D 2270/304; F05D 2270/335

(57) ABSTRACT

The invention relates to a device for starting a gas turbine, comprising an initiation system able, on command, to rotate said gas turbine.

The starting device comprises means for receiving information representing the rotation speed of the gas turbine, means for calculating a set torque value according to said information representing the rotation speed of the gas turbine, and means for transmitting said set torque value to the initiation system, and the means for calculating the set torque value are suitable for making a comparison of the information representing the rotation speed of the gas turbine with a predetermined speed profile and calculating the set torque value from said comparison.

### 1. TECHNICAL FIELD OF THE INVENTION

The invention relates to a device for starting a gas turbine, a method for starting a gas turbine and a method for regulating the rotation speed of a gas turbine. In particular, the invention relates to a starting device, a starting method and a method for regulating the rotation speed of a gas turbine of an aircraft turbine engine.

### 2. TECHNOLOGICAL BACKGROUND

On aircrafts, the power necessary for starting a gas turbine (GT) is supplied either by batteries or by an external auxiliary unit (a cart on the ground or the supply network of an airport), or by the electrical generation of another gas turbine of the aircraft (typically an auxiliary power unit).

In the starting phase, the acceleration of the gas turbine depends both on the torque applied by the starting device of the gas turbine and the resisting torques caused for example by the accessory box, the rotors, the equipment driven by the accessory box or take-ups of mechanical power on the rotor or rotors.

These resisting torques fluctuate significantly according to the environment in which the gas turbine is situated, in particular the temperature and the altitude of the aircraft. Obtaining a reproducible and reliable start-up profile under these conditions is complex since the resisting torque information presented by the gas turbine is generally not available.

In addition, the torque applied by the starting device is sometimes difficult to measure, either because of the design of the device or of the turbine or because measuring this torque would cause perturbations to the rotation of the turbine, giving rise to losses of reliability. Such a torque measurement moreover requires measuring means generally presenting an additional mass and space requirement in the gas turbine.

### 3. OBJECTIVES OF THE INVENTION

The invention aims to overcome at least some of the drawbacks of the known gas turbine starting devices and methods.

In particular, the invention aims to provide, in at least one embodiment of the invention, a starting device and method that make it possible to control the starting of gas turbine without requiring direct measurement of the turbine torque.

The invention also aims to provide, in at least one embodiment, a starting device that provides robust starting of the gas turbine.

The invention also aims to provide, in at least one embodiment, a starting device that makes it possible to apply to the turbine a starting profile in a plurality of phases.

The invention also aims to provide, in at least one embodiment, a starting device that allows good control of the transient starting phases.

The invention also aims to provide, in at least one embodiment, a starting device affording a gain in performance.

The invention also aims to provide, in at least one embodiment, a starting device affording a reduction in the starting time.

The invention also aims to provide, in at least one embodiment, a method for regulating the rotation speed of a gas turbine.

### 4. DISCLOSURE OF THE INVENTION

To do this, the invention relates to a device for starting a gas turbine, comprising an initiation system able to rotate said gas turbine on command, characterised in that it comprises:
means for receiving information representing the rotation speed of the gas turbine,
means for calculating a set torque value according to said information representing the rotation speed of the gas turbine,
means for transmitting said set torque value to the initiation system, and in that the means for calculating the set torque value are suitable for making a comparison of the information representing the rotation speed of the gas turbine with a predetermined speed profile and calculating the set torque value from said comparison.

A starting device according to the invention therefore allows starting of the turbine according to information representing the speed of the gas turbine by applying a set starting torque value by means of the initiation system. Unlike the torque of the turbine, and in particular the resisting torques of the turbine, the rotation speed of the gas turbine can be measured, for example by a speed sensor that transmits information representing the rotation speed to the means for receiving this information, for example in the form of digital data carried by an electrical signal. The set torque value makes it possible to regulate the rotation of the turbine very precisely according to a predetermined rotation speed profile of the gas turbine during starting and throughout the period of this starting, and therefore allows a more robust starting.

The comparison made by the means for calculating the set torque value is a determination of the difference between the information representing the rotation speed of the turbine (referred to as the actual speed) and a required speed, defined by the predetermined speed profile.

Advantageously and according to the invention, the device comprises:
a fuel metering device suitable for injecting fuel into a combustion chamber of said gas turbine,
means for calculating a set fuel metering value according to said information representing the speed, and
means for transmitting the fuel metering value to said fuel metering device, and the means for calculating the set fuel metering value are suitable for making a comparison of the information representing the rotation speed of the gas turbine with a predetermined speed profile and calculating the set fuel metering value from said comparison.

According to this aspect of the invention, the device makes it possible to control the injection of the fuel into the combustion chamber of the gas turbine when the gas turbine is started in order to supply additional torque to the turbine that is added to the torque provided by the initiation system. Thus the device, according to the information representing the speed, controls the setting in rotation of the gas turbine through the initiation system and the fuel metering device in order better to control various starting phases. In particular, the transitions between the phases where the setting in rotation is due either solely to the initiation system or solely to the fuel injection or to a combination of the two, are more robust.

The comparison made by the means for calculating the set fuel metering value is a determination of the difference between the information representing the rotation speed of the turbine (referred to as the actual speed) and a required speed, defined by the predetermined speed profile.

Advantageously and according to the invention, the means for receiving information representing the rotation speed of the gas turbine, the means for calculating the set torque value, the means for calculating the set fuel metering value, the means for transmitting the set torque value and the means for transmitting the set fuel metering value are contained in a control unit controlling said gas turbine.

The control unit used is for example an engine control unit (ECU) allowing the control of a multitude of elements of the turbine by means of a multitude of actuators, or a FADEC (Full Authority Digital Engine Control).

According to this aspect of the invention, the control unit makes it possible to put together the means for calculating and transmitting the set torque value and the set fuel metering value in a single item of equipment. The control unit can also control other functionalities of the gas turbine.

Advantageously and according to the invention, the initiation system is able to rotate the gas turbine by means of a relay box.

According to this aspect of the invention, the relay box allows transmission of the torque from the initiation system to the gas turbine, optionally modified by a reduction coefficient.

Advantageously and according to the invention, the initiation system comprises an electrical machine able to rotate said gas turbine and a system for controlling the electrical machine configured to receive said set torque value and to demand the power supply to said electrical machine according to the set torque value.

According to this aspect of the invention, the system for controlling the electrical machine receives the set torque value, for example by means of its control electronics, and translates it into a command to the electrical machine, which applies the torque to the gas turbine.

The invention also relates to a method for regulating the rotation speed of a gas turbine configured so as to be driven by an initiation system, characterised in that it comprises:
a step of receiving information representing the rotation speed of the gas turbine,
a step of comparing the information representing the rotation speed of the gas turbine with a predetermined speed profile,
a step of calculating a set torque value from a result of said comparison,
a step of transmitting said set torque value to the initiation system.

A regulation method according to the invention therefore makes it possible to create a regulation loop for the rotation speed of the turbine in order to afford effective control of said speed so as to follow a predetermined speed profile.

The comparison made during the comparison step is a determination of the difference between the information representing the rotation speed of the turbine (referred to as the actual speed) and a required speed, defined by the predetermined speed profile. The result of the comparison is the determined difference, which is used for calculating the set torque value.

Advantageously and according to the invention, the method comprises:
a step of calculating a set fuel metering value from the result of said comparison,
a step of transmitting the set fuel metering value to a fuel metering device suitable for injecting fuel into a combustion chamber of the gas turbine according to said set fuel metering value.

Advantageously, the regulation method according to the invention is implemented by the starting device according to the invention.

Advantageously, the starting device according to the invention implements the regulation method according to the invention.

The invention also relates to a method for starting a gas turbine, characterised in that the rotation speed of the gas turbine is regulated according to a regulation method according to the invention, and in that it comprises, successively and in this order:
a step of initiation of the gas turbine by means of the initiation system, during which the set torque value is calculated so that the rotation speed of the gas turbine varies from a zero speed to a so-called ignition speed,
a step of igniting the gas turbine,
a step of starting up the gas turbine, during which the set torque value and the set fuel metering value are calculated so as to increase the rotation speed of the gas turbine up to a so-called transition speed,
a transition step, during which the set torque value is fixed and the set fuel metering value is calculated so as to increase the rotation speed of the gas turbine.
a normal-regime step, during which the set torque value is zero and the set fuel metering value is calculated so as to vary the rotation speed of the gas turbine.

A starting method according to the invention therefore affords a robust and efficient starting of the gas turbine by regulating the speed according to the regulation method. The speed is regulated according to a plurality of starting phases in order to afford rapid and efficient starting. The transitions between the phases are improved by the calculation of the set torque values of the initiation system and the set fuel metering value of the fuel metering device according to the information representing the rotation speed of the gas turbine. Furthermore, the starting method of the invention is reproducible over a plurality of startings of the gas turbine, since it depends on the rotation speed of the gas turbine and is insensitive to the variations in external conditions.

Preferably, at the step of igniting the gas turbine, the set torque value is calculated so as to maintain the rotation speed of the gas turbine at the ignition speed until the fuel injected by the fuel metering device according to the set fuel metering value combusts.

The stabilisation of the speed to the ignition speed during the ignition step allows optimised ignition of the gas turbine and reduces the number of aborted startings due to an excessively low or excessively high ignition speed.

Advantageously, the starting method according to the invention is implemented by the starting device according to the invention.

Advantageously, the starting device according to the invention implements the starting method according to the invention.

The invention also relates to a gas turbine comprising a device according to the invention.

The invention also relates to a turbine engine comprising a gas turbine according to the invention.

The invention also relates to a starting device, a starting method, a regulation method, a gas turbine and a turbine engine characterised in combination by all or some of the features mentioned above or below.

### 5. LIST OF FIGURES

Other aims, features and advantages of the invention will emerge from a reading of the following description given solely non-limitatively and which refers to the accompanying figures, in which:

FIG. 1 is a schematic representation of a starting device according to an embodiment of the invention,

FIG. 2 is a schematic representation of a regulation method according to an embodiment of the invention,

FIG. 3 is a predetermined speed profile of a gas turbine started according to a starting method according to an embodiment of the invention.

### 6. DETAILED DESCRIPTION OF AN EMBODIMENT OF THE INVENTION

The following embodiments are examples. Although the description refers to one or more embodiments, this does not necessarily mean that each reference relates to the same embodiment, or that the features apply only to one embodiment. Simple features of various embodiments may also be combined in order to provide other embodiments.

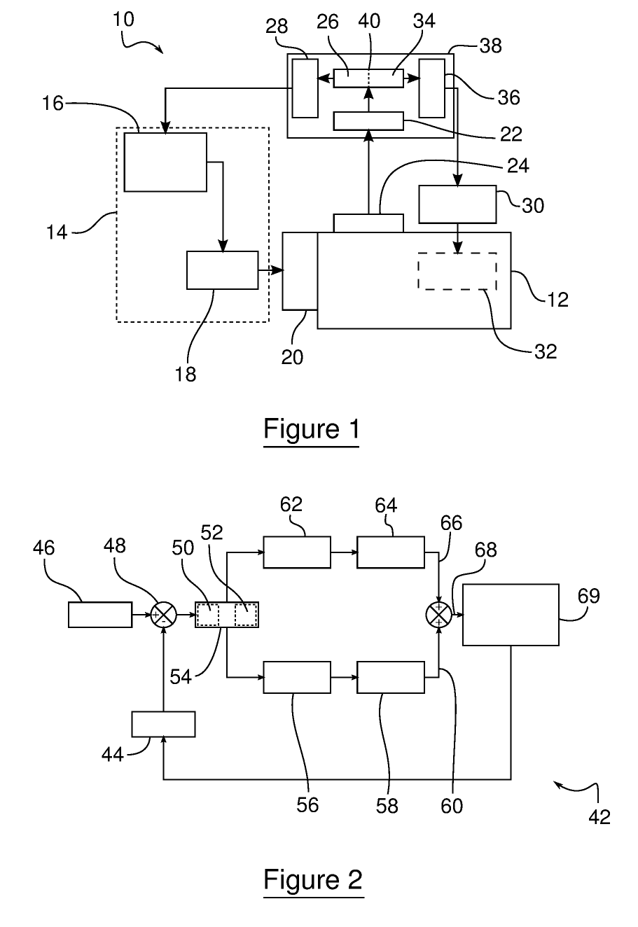

FIG. 1 shows schematically a device 10 for starting a gas turbine 12 according to an embodiment of the invention. The objective of the starting device 10 is to allow the starting of the turbine 12 when the latter is not rotating. In the absence of rotation, the gas in the turbine 12 cannot be burnt in order to rotate the turbine 12. Thus, to allow the starting of the turbine 12, an initiation system 14 is connected to the turbine in order to be able to trigger the rotation thereof. According to the embodiment depicted in FIG. 1, the initiation system 14 is composed of an electrical machine 18, for example an alternator, and a system 16 for controlling the electrical machine, for example an inverter. The system 16 for controlling the electrical machine provides the electrical power to the electrical machine 18 so that the latter can rotate the gas turbine 12, by means of a relay box 20.

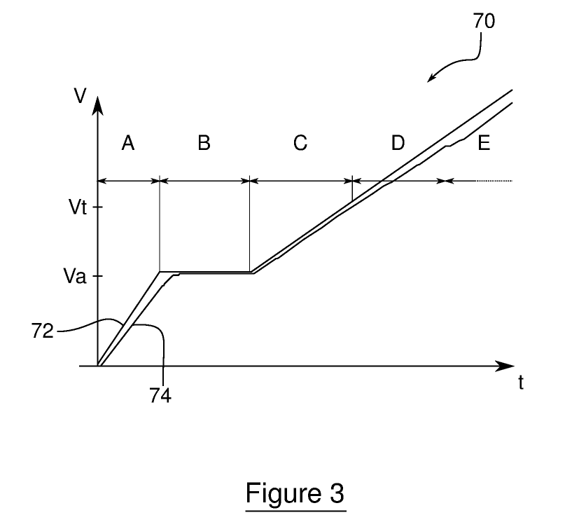

To control the initiation system 14, the starting device 10 comprises means for applying a predetermined speed profile to the turbine 12. An example of such a predetermined speed profile is described later in the description with reference to FIG. 3. These means are in particular:
means 22 for receiving information representing the rotation speed of the gas turbine 12. This information is for example transmitted by a sensor 24 for the rotation speed of the turbine 12.
means 26 for calculating a set torque value according to said information representing the rotation speed of the gas turbine 12, in particular from a comparison between this information representing the rotation speed and the predetermined speed profile. These calculation means 26 make it possible to determine the set torque value that must be applied to the gas turbine 12 by the initiation system 14.
means 28 for transmitting said set torque value to the initiation system 14, and more particularly to the system 16 for controlling the electrical machine. The system 16 for controlling the electrical machine is then responsible for controlling the electrical machine 18 through its electrical supply, in order to apply to the gas turbine 12 the torque corresponding to the set torque value transmitted.

In this embodiment, the starting device 10 also comprises a fuel metering device 30, which injects fuel into a combustion chamber 32 of the gas turbine 12. One type of fuel metering device 30 is for example an FMU (fuel metering unit). The fuel metering device 30 injects the fuel into the combustion chamber 32 of the gas turbine 12 so that the fuel is burnt, this combustion permitting the rotation of the gas turbine 12, in particular in normal operating regime, following starting.

To allow a suitable metering of fuel, the starting device 10 comprises means 34 for calculating a set fuel metering value according to the information representing the rotation speed of the gas turbine 12 and means 36 for transmitting the set fuel metering value to the fuel metering device. The set fuel metering value is calculated according to the rotation speed of the turbine, in particular from a comparison of this rotation speed of the turbine with the predetermined speed profile and the injection of fuel allows the combustion thereof in the turbine in order to provide an additional torque to the gas turbine, which is added to the torque provided by the initiation system 14.

In this embodiment, the means 22 for receiving the information representing the speed, the means 26 for calculating the set torque value, the means 34 for calculating the set fuel metering value, the means 28 for transmitting the set torque value and the means 36 for transmitting the set fuel metering value are contained in a single item of equipment, referred to as the control unit 38. This control unit 38 makes it possible to simultaneously control the initiation system 14 and the fuel metering device 30 to allow a more robust starting. This control unit 38 may further have more functionalities relating to the gas turbine 12, not described here. The equipment that can serve as a control unit 38 is for example an ECU (engine control unit), in particular a FADEC (Full Authority Digital Engine Control), which is equipment regularly used in the aeronautical field for use of the gas turbine 12 as a turbine of a turbine engine.

Furthermore, in this embodiment, the means 26 for calculating the set torque value and the means 34 for calculating the set fuel metering value are combined in the same item of computing equipment 40. This allows an adjustment between the two set values in order to obtain the required torque of the gas turbine 12 by combining the effects of the initiation system 14 and the fuel metering device 30.

FIG. 2 shows schematically a starting method 42 according to an embodiment of the invention. The method 42 is advantageously implemented by the device 10 described in relation to FIG. 1. The method 42 comprises a step 44 of receiving information representing the rotation speed of the gas turbine 12. This information is compared, during a comparison step 48, with a predetermined speed profile 46, as for example described with reference to FIG. 3. This comparison step 48 makes it possible to determine the difference between the actual rotation speed and the required rotation speed defined by the predetermined speed profile 46, and said determined difference then makes it possible, during a step 50 of calculating the set torque value and a step 52 of calculating the set fuel metering value, to determine the set torque value and the set fuel metering value according to the actual rotation speed and the required rotation speed of the turbine 12, and optionally according to a starting phase in which the turbine 12 is situated. In this embodiment, the two calculation steps 50, 52 are combined in a single step 54 in order to provide a more robust regulation using both the initiation system 14 and the injection of fuel by the fuel metering device 30 in order to provide the torque necessary for regulation of the speed.

The set torque value is transmitted to the system controlling the electrical machine during a step 56 of transmitting the set torque value. The system 16 controlling the electrical machine controls the electrical machine 18 according to this set value, which then applies a torque to the turbine 12 during a step 58 of applying the torque of the initiation system. The resulting torque is shown by the arrow 60.

Moreover, the set fuel metering value is transmitted to the fuel metering device during a step 62 of transmitting the set fuel metering value, which allows the injection of fuel into the combustion chamber of the gas turbine. The combustion of the gas makes it possible to apply a torque to the turbine 12 during a step 64 of applying the torque of the fuel metering device. The resulting torque is represented by the arrow 66.

The total torque applied to the turbine, represented by the arrow 68, is therefore the addition of the two torques coming from the initiation system 14 and the fuel metering device 30. This total torque makes it possible to rotate the turbine 12 at a certain speed, represented by the step 69, information representing which is received during the step 44 of receiving information representing the speed: the regulation method thus constitutes a closed regulation loop.

FIG. 3 shows a predetermined speed profile of a gas turbine started according to a starting method according to an embodiment of the invention. The predetermined speed profile represents the rotation speed V as a function of time t, according to two curves, a set speed value curve 72, representing the rotation speed that the turbine should theoretically follow, and the measured-speed curve 74 representing the rotation speed of the turbine 12 actually measured.

The predetermined speed profile 70 makes it possible to distinguish the various steps of a method for starting the gas turbine 12:

At the initiation step A, the initiation system 14 drives only the rotation of the gas turbine 12, the combustion of the gas in the turbine 12 not having begun.

The ignition step B ignites the gas injected into the combustion chamber 32 of the gas turbine 12 by the fuel metering device 30 in order to cause the combustion of the gas and to cause the rotation of the gas turbine 12. To provide effective ignition, the rotation speed of the gas turbine 12 is maintained at a so-called ignition speed Va.

At the step C of starting the gas turbine 12, the rotation speed of the turbine 12 increases progressively, mainly because of the action of the initiation system 14 and partly because of the combustion of the fuel injected. The set torque value and the set metering value are calculated so that the action of the initiation system 14 and the combustion of the fuel injected with the air aspirated by the gas turbine apply the required torque to the gas turbine 12.

Once a so-called transition speed Vt is reached, the starting method passes into the transition step D, during which the set torque value is fixed, and the set fuel metering value is calculated so as to increase the rotation speed of the turbine 12. Thus it is the fuel that regulates the speed of the turbine 12 so as to follow the predetermined speed profile, the initiation system 14 applying only a fixed torque.

Finally, at the normal-regime step E, the starting is ended and the gas turbine 12 goes back into normal regime. The initiation system 14 is stopped and the turbine 12 is rotated only by the combustion of the fuel injected by the fuel metering device 30.

1. Device for starting a gas turbine, comprising an initiation system able to rotate said gas turbine on command,
wherein it comprises:
means for receiving information representing the rotation speed of the gas turbine,
means for calculating a set torque value according to said information representing the rotation speed of the gas turbine,
means for transmitting said set torque value to the initiation system,
and in that the means for calculating the set torque value are suitable for making a comparison of the information representing the rotation speed of the gas turbine with a predetermined speed profile and calculating the set torque value from said comparison.

2. Starting device according to claim 1, further comprising:
a fuel metering device suitable for injecting fuel into a combustion chamber of said gas turbine,
means for calculating a set fuel metering value according to said information representing the speed, and
means for transmitting the set fuel metering value to said fuel metering device,
and in that the means for calculating the set fuel metering value are suitable for making a comparison of the information representing the rotation speed of the gas turbine with a predetermined speed profile and calculating the set fuel metering value from said comparison.

3. Starting device according to claim 1, wherein the means for receiving information representing the rotation speed of the gas turbine, the means for calculating the set torque value, the means for calculating the set fuel metering value, the means for transmitting the set torque value and the means for transmitting the set fuel metering value are contained in a control unit controlling said gas turbine.

4. Starting device according to claim 1, wherein said initiation system is able to rotate the gas turbine by means of a relay box.

5. Starting device according to claim 1, wherein said initiation system comprises an electrical machine able to rotate said gas turbine, and a system for controlling the electrical machine configured so as to receive said set torque value and to control the power supply to said electrical machine according to the set torque value.

6. Method for regulating the rotation speed of a gas turbine configured so as to be driven by an initiation system, wherein it comprises:
a step of receiving information representing the rotation speed of the gas turbine,
a step of comparing the information representing the rotation speed of the gas turbine with a predetermined speed profile,
a step of calculating a set torque value from a result of said comparison,
a step of transmitting said set torque value to the initiation system.

7. Regulation method according to claim 6, further comprising:
a step of calculating a set fuel metering value from the result of said comparison,
a step of transmitting the set fuel metering value to a fuel metering device suitable for injecting fuel into a combustion chamber of the gas turbine according to said set fuel metering value.

8. Method for starting a gas turbine, wherein the rotation speed of the gas turbine is regulated according to a regulation method according to claim 7, and in that it comprises, successively and in this order:
a step (A) of starting the gas turbine by means of the initiation system, during which the set torque value is calculated so that the rotation speed of the gas turbine varies from a zero speed to a so-called ignition speed (Va),
a step (B) of igniting the gas turbine, during which the set torque value is calculated so as to maintain the rotation speed of the gas turbine at the ignition speed until the fuel injected by the fuel metering device according to the set fuel metering value combusts,
a step (C) of starting up the gas turbine, during which the set torque value and the set fuel metering value are calculated so as to increase the rotation speed of the gas turbine up to a so-called transition speed,
a transition step (D), during which the set torque value is fixed and the set fuel metering value is calculated so as to increase the rotation speed of the gas turbine,
a normal-regime step (E), during which the set torque value is zero and the set fuel metering value is calculated so as to vary the rotation speed of the gas turbine.

9. Gas turbine, comprising a starting device according to claim 1.

10. Turbine engine, comprising a gas turbine according to claim 9.
